(19) United States
(12) Patent Application Publication
(10) Pub. No.: US 2023/0316931 A1
(43) Pub. Date: Oct. 5, 2023

(54) POSITIONING ALERT SYSTEM FOR AIRCRAFT

(71) Applicants: Michael Ryan, Jefferson City, MO (US); Ronald A. Lueck, Merritt Island, FL (US)

(72) Inventors: Michael Ryan, Jefferson City, MO (US); Ronald A. Lueck, Merritt Island, FL (US)

(21) Appl. No.: 18/131,230

(22) Filed: Apr. 5, 2023

Related U.S. Application Data
(60) Provisional application No. 63/327,677, filed on Apr. 5, 2022.

(51) Int. Cl. G08G 5/00; B64D 43/02

(52) U.S. Cl. CPC G08G 5/0021; B64D 43/02

(57) ABSTRACT

The present positioning alert system includes components for monitoring altitude, vertical speed, descending/ascending angles and rates, and gear positioning status and providing visual and aural alerts to the pilot.

### CROSS-REFERENCE TO PRIOR APPLICATION

The present application claims the benefit of priority to U.S. Provisional Application No. 63/327,677 filed Apr. 5, 2022, the entirety of which is incorporated herein by reference.

### BACKGROUND

The present subject matter relates generally to an instrument that provides information to the pilot regarding depth perception and pitch attitude during landing and take-off. More specifically, the present invention relates to a system that includes components for monitoring altitude, vertical speed, descending/ascending angles and rates, and gear positioning status and providing visual and aural alerts to the pilot.

Floatplanes, which include seaplanes and amphibious aircraft, generally include a wing or primary airfoil having first and second opposing wingtips secured to a top of a fuselage. A pair of floats is secured to an underside of the fuselage for takeoff and landing on water.

When landing a seaplane on a body of water, it can be difficult to accurately and precisely assess the distance between the seaplane and the water as well as the pitch of the plane as the plane approaches the water, particularly when the water is reflective or glassy. Pilots experience similar difficulties during take-off, with a need to manually and quickly change (reduce) the pitch attitude at the hull speed when hydroplaning can be achieved. The seaplane cannot takeoff without achieving hydroplaning, which represents a lower drag to allow acceleration to liftoff. The more quickly that hydroplaning can be accomplished, the shorter, and therefore the safer, the takeoff run.

Accordingly, there is a need for a monitoring system that provides real-time, precise, and accurate data to the pilot, as described herein.

### SUMMARY

To meet the needs noted above and others, the present disclosure provides a positioning alert system that improves the pilot's awareness of height above ground (AGL), rate of descent, water speed, and pitch during landings and takeoffs. The positioning alert system is described herein with reference to floatplanes, although the system does have applications for land planes as well.

In one embodiment, the positioning alert system includes an inclinometer, a radar altimeter, a vertical speed indicator, a GPS-based ground or water speed, in communication with a display provided on a dashboard in the cockpit. Each sensor, indicator, or device tracks and monitors aspects of the floatplane and communicates data as well as alerts to the cockpit display.

The positioning alert system also includes at least one controller for controlling each device and a memory coupled to the controller and configured to store program instructions executable by the controller(s) to provide the functionality disclosed herein. In some embodiments, the positioning alert system may include a plurality of controllers, each controller dedicated to one or more components of the positioning alert system. A database may be provided for storing data such as threshold levels to trigger alerts and other messages. The positioning alert system may also include a power source, such as a battery, that provides power to each component described herein.

The inclinometer monitors an angle of a longitudinal axis of the aircraft to horizon or water level, referred to herein as the angle of incidence. The vertical speed indicator determines a vertical speed of the floatplane. The radar altimeter determines an altitude of the floatplane above the water level utilizing ultrasound, radar, or lidar altitude sensor or technology. A global positioning system (GPS) unit can measure ground or water speed. “Water speed” refers to the speed of the aircraft relative to the speed of the current in the water. The controller may activate or deactivate the radar altimeter and/or the vertical speed indicator when the controller detects the floatplane above a minimum threshold height and/or positioned over land.

The positioning alert system receives data from the inclinometer, the radar altimeter, and the vertical speed indicator, determines an angle of incidence of the floatplane in real time, and compares the angle of incidence with threshold data stored in the database. The data received from the sensors and devices is real-time, instantaneous data related to the floatplane. The threshold data includes, for example, threshold angles of incidence that are minimum levels needed for hydroplaning. The threshold angles of incidence are based on water speed, aspects of the plane, and other factors, including user-selected angles of incidence associated with certain conditions. During use, the positioning alert system identifies a threshold angle of incidence based on the current conditions, such as water speed, environmental conditions, and the like, and compares the real-time angle of incidence with the identified threshold angle of incidence.

This data increases safety in both takeoff and landings by (1) indicating the safe angle of incidence of the floats to the water (i.e., horizon) while landing to avoid a nose over accident, (2) measuring water speed by combining this data with GPS data and sending an alert to indicate when the speed is sufficient to allow hydroplaning so the pilot can transition to the appropriate angle of incidence, i.e., to “get on the step” (“on the step”=hydroplaning with minimal hydrodynamic drag in order to allow acceleration of the seaplane so takeoff can be achieved), and (3) indicating the angle of incidence to allow the pilot to rapidly transition the pitch attitude to the step (hydroplane stage) to shorten the takeoff run. Transition to the step, i.e., hydroplaning of the floats, is dependent on water speed, not ground or air speed.

In the positioning alert system, the controller may provide aural alerts to the pilot based on data tracked by the inclinometer. For safety, the controller may activate or disable the aural alerts for the inclinometer with power up for water takeoff assist and/or at a specific height above ground or water level on landing. The controller can also indicate an altitude reference, zeroed to the local known altitude based on GPS or map coordinates, to adjust barometric altimeter when no local barometer is available. In some embodiments, the controller triggers a takeoff alert when the GPS altitude is equal to the barometric altitude, and a landing alert when the altitude is greater than a preselected GPS determined or barometric altitude AGL, such as 25 feet. The controller may disable the inclinometer when the landing gear is down for amphibious seaplanes and/or includes a disable button for deactivating the inclinometer.

The controller can also track the angle of descent and indicate a preferred angle for float landing with aural and display notifications and/or alerts based on data provided by the inclinometer. The controller may disable aural alerts when the gear is down and/or when the floatplane is within a predetermined distance of a runway extension, such as one mile, based on GPS data. The controller may also send an aural alert of “gear down” when the floatplane reaches a predetermined height above water level to avoid a wheels down water landing accident. The controller may also trigger an aural alert of “airspeed too high, go around” when the airspeed is above a minimum threshold and the height of the floatplane is above a threshold height above water level.

The controller may also provide aural alerts to the pilot based on information collected by the altitude sensor and/or the vertical speed indicator.

An object of the invention is to provide a solution to the difficulties encountered by pilots when landing a seaplane on water. Specifically, the present invention enables the pilot to assess accurately and precisely the distance between the seaplane and the water as well as the pitch of the plane as the plane approaches the water, particularly when the water is reflective or glassy.

Another object of the invention is to provide a solution to difficulties encountered by pilots during take-off. Specifically, the present invention enables the pilot to achieve hydroplaning efficiently by allowing the pilot to assess pitch attitude at the hull speed and manually and quickly reduce the pitch attitude as needed.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE FIGURES

The drawing figures depict one or more implementations in accord with the present concepts, by way of example only, not by way of limitations. In the figures, like reference numerals refer to the same or similar elements.

FIG. 1 is a diagram of a positioning alert system described in the present application.

FIG. 2 is front perspective view of a display of the positioning alert system of FIG. 1.

FIG. 3 is front perspective view of a further display of the positioning alert system of FIG. 1.

### DETAILED DESCRIPTION

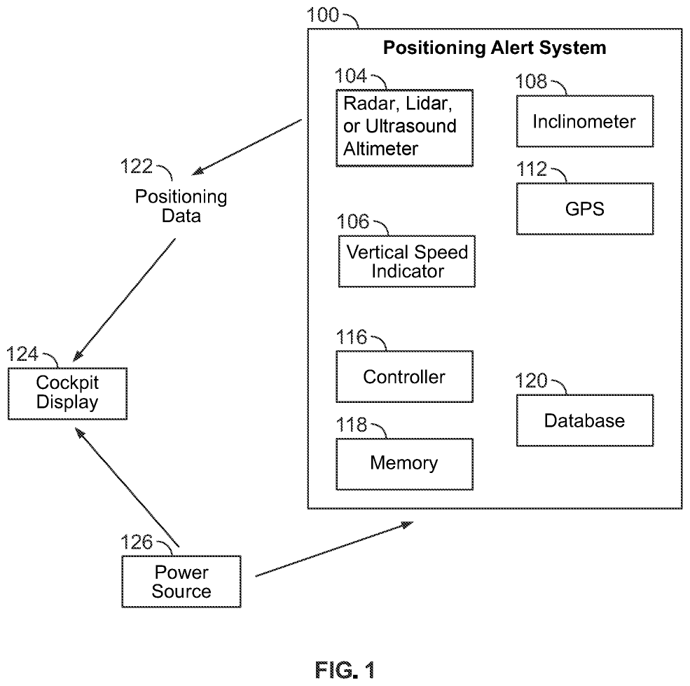

FIG. 1 illustrates a schematic of a positioning alert system 100 of the present application for use with a floatplane. The positioning alert system 100 improves the pilot's awareness of height above ground (AGL), rate of descent, water speed during ground phase of seaplane takeoff, and pitch during landings and takeoffs as described in greater detail below. The positioning alert system 100 is described herein with reference to floatplanes, although the system does have applications for land planes as well.

In the illustrated embodiment, the positioning alert system 100 includes a radar altimeter 104, a vertical speed indicator 106, an inclinometer 108, and a global positioning system (GPS) unit 110. The data received from the sensors and devices 102, 104, 106, 108, 110 is real-time, instantaneous data related to the floatplane.

The inclinometer 108 may be an electronic gyroscope that continuously calculates attitude and pitch of the floatplane relative to horizontal. In some embodiments, the inclinometer 108 may include an attitude and heading reference system (AHRS) that calculates the pitch attitude as part of the gyroscope and/or in addition to the gyroscope. In one embodiment, the gyroscope is a one-axis gyro, in contrast to a three-axis gyroscope used in standard aircraft navigation. In other embodiments, the positioning alert system utilizes a three-axis gyroscope.

The radar altimeter 104 measures distance based on time of flight calculations to and from the sender and its receiver with the speed of sound or the speed of light known. The radar altimeter 104 may utilize ultrasound, radar, or lidar altitude sensor or technology. Radar uses non-focused electromagnetic radiation wavelengths, while lidar (light detection and ranging) uses focused narrow electromagnetic wavelength radiation. Ultrasound technology may also be used.

The positioning alert system 100 monitors the water speed of the floatplane, or speed of the floatplane relative to the speed of the water. In one embodiment, the water speed is determined using the GPS unit 110, which provides the water speed of the floatplane by zeroing out a speed of the current of the water below the floatplane. In other embodiments, the water speed may be determined by any conventional device.

The positioning alert system 100 also includes a controller 116 and memory 118. The system 100 may include a plurality of controllers 116, each dedicated to a sensor or device of the system 100. The controller 116 communicates with each component 102, 104, 106, 108, 110 through wired or wireless interfaces. The system 100 also may include a database 120 that stores threshold data, such as threshold angles of incidence associated with ground/water speed and other factors. The controller 116 is also in communication with a cockpit display 124, which may be a specific display for the positioning alert system 100 or may be integrated into an existing cockpit display in the floatplane. A power source 126 provides power to the positioning alert system 100.

The positioning alert system 100 receives data from each component 102, 104, 106, 108 and adaptively and dynamically determines positioning data 118 of the floatplane. For example, the positioning alert system 100 monitors the angle of incidence, i.e., the angle of the longitudinal axis of the aircraft relative to the horizon, or water, the water speed, the vertical speed of the floatplane, and the distance above ground through data provided by the inclinometer 108, the GPS unit 110, the vertical speed indicator 106, and the radar altimeter 104, respectively. This data provides insight into the positioning of the floatplane, thereby increases safety in both takeoff and landings. For example, the system 100 then compares the angle of incidence against a threshold angle of incidence for a given water speed, determines a safe angle of incidence of the floats to the water (i.e., horizon) while landing to avoid a nose over accident, and sends an alert to the pilot when the safe angle of incidence is achieved. The system 100 may combines the pitch data with data from the GPS unit 110 and sends an alert to the pilot when the speed and pitch are sufficient to allow hydroplaning so the pilot can transition to the appropriate angle of incidence, i.e., to “get on the step” (“on the step”=hydroplaning with minimal hydrodynamic drag in order to allow acceleration of the seaplane so takeoff can be achieved. The system 100 can also use this data to determine and indicate the angle of incidence to allow the pilot to rapidly transition the pitch attitude to the step (hydroplane stage) to shorten the takeoff run. Transition to the step, i.e. the hydroplaning of the floats, is dependent on water speed, not ground or air speed.

In the positioning alert system 100, the controller 116 may provide aural alerts to the pilot based on data tracked by the inclinometer 108. For safety, the controller 116 may activate or disable the aural alerts for the inclinometer with power up for water takeoff assist and/or at a specific height above ground or water level on landing. The controller 116 can also indicate an altitude reference, zeroed to the local known altitude based on GPS or map coordinates, to adjust barometric altimeter when no local barometer is available. In some embodiments, the controller 116 triggers a takeoff alert when the GPS altitude is equal to the barometric altitude and a landing alert when the altitude is greater than a preselected GPS determined or barometric altitude AGL, such as 25 feet. The controller may disable the inclinometer when the landing gear is down for amphibious seaplanes and/or includes a disable button for deactivating the inclinometer.

The controller 116 can also track the angle of descent and indicate a preferred angle for float landing with aural and display notifications and/or alerts based on data provided by the inclinometer. During takeoff, the controller 116 tracks the float angle, or the angle of incidence, and compares the angle of incidence with the optimal float angle (or range of angles) to get on the step. The optimal angles of incidence for preset calculated water speeds may be stored on the database 120.

For example, when the angle of incidence reaches the optimal angle of incidence for a preset calculated water speed, which is known to allow hydroplaning, the controller 116 transmits an aural alert to the pilot instructing them to “get on step,” aiding the pilot in manually adjusting the seaplane pitch attitude. Another aural alert communicating “nose down” is triggered when the angle of descent is greater than a target landing angle, a maximum target landing angle, or a range of angles in landing mode. The aural alert communicating “nose up” is triggered when the angle of descent is less than a target landing angle, a minimum target landing angle, or a range of angles in landing mode. The aural alert communicating “on step” is triggered when the pitch angle is within a predefined range during takeoff empirically determined and previously calculated for each seaplane while at hydroplaning speed and stored on the database 120. The target landing angles and the pitch angles associated with certain conditions such as water speed, environmental conditions, and other aspects, may be determined based on flight history of the floatplane and/or may be user-selected values, and are stored in the database 120.

Further, the aural alert may be disabled manually or automatically when the floatplane reaches a minimum distance above ground level. In some embodiments, the controller 116 can allow manual adjustment of a baseline pitch angle used to calculate the angles of descent and ascent. Other aural alerts based on data collected by the controller are envisioned.

The controller 116 may disable aural alerts when the gear is down and/or when the floatplane is within a predetermined distance of a runway extension, such as one mile, based on GPS data. The controller 116 may also send an aural alert of “gear down” when the floatplane reaches a predetermined height above water level to avoid a wheels down water landing accident. The controller 116 may also trigger an aural alert communicating “airspeed too high, go around” or “airspeed too high, abort landing” when the airspeed is above a minimum threshold and the height of the floatplane is above a threshold height above water level.

The radar altimeter 104 measures the altitude of the floatplane above the water level and may utilize ultrasound, radar, or lidar altitude sensors/technology. For example, in one embodiment, the radar altimeter 104 includes an ultrasound transducer and receiver on the underside of the fuselage. The vertical speed indicator 106 measures the rate of climb or descent of an aircraft and may be analog or digital, and may be measured directly or calculated. In some embodiments, the controller 116 calculates the vertical speed from the radar altimeter 104. The radar altimeter 104 and the vertical speed indicator 106 together reduce risks associated with glassy water landings by indicating (1) the instantaneous height and (2) the descent rate, i.e., the instantaneous vertical speed since visual assessment of height above glassy water is known to be unreliable.

The controller 116 may activate or deactivate the radar altimeter 104 and/or the vertical speed indicator 106 when the controller 116 detects the floatplane above a minimum threshold height and/or positioned over land. The controller 116 may transduce a digital ultrasound signal from the radar altimeter 104 to an aural alert calling out the height above water level or ground level. If the vertical speed indicator is digital, the controller 116 may transduce a digital vertical speed to an aural alert calling out the vertical speed.

The controller 116 may also provide aural alerts to the pilot based on information collected by the radar altimeter 104 and/or the vertical speed indicator 106. For example, the controller 116 may provide a series of beeps or tones progressing in speed and/or volume when the altitude is less than 18 feet. The controller 116 may provide aural alerts to call out the height above ground level when the height detected by the altitude sensor is below 18 feet. The controller 116 can provide an alert of “descent rate too fast, add power” when the descent rate is above a preset threshold value and, in some embodiments, within a certain height above ground level.

Regarding the inclinometer 108, the cockpit display 124 may include the current angle, the ideal angle for landing, the ideal angle for on step, and an angle range for an alert zone. The cockpit display 124 may also include the target landing ground speed range, the takeoff range for step (zeroed and adjusted for water speed prior to takeoff), and an alert zone.

Regarding the radar altimeter 104, the cockpit display 124 may include the height above ground level as measured by the altitude sensor 104, a target descent rate range for landing on glassy water, and/or a target descent rate range for a standard water landing.

In some embodiments, the data received from each component is updated five times per second. In other embodiments, data received from each component is updated more frequently.

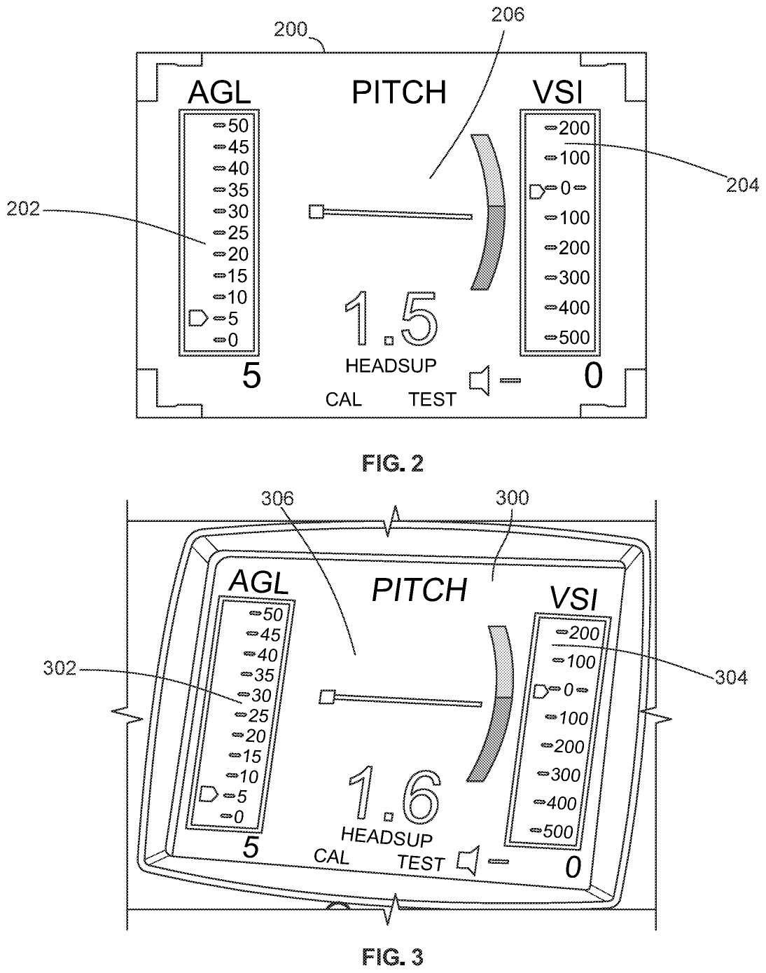

FIGS. 2 and 3 illustrate example displays 200, 300 viewed on the cockpit display 120. Each display 200, 300 includes height above ground (AGL) 202, 302, rate of descent (VSI) 204, 304, water speed, and pitch 206, 306. Additional positioning data 122 as described herein may also be provided in displays 200, 300.

As noted above, aspects of the systems 100 and methods described herein are controlled by one or more controllers 116. The one or more controllers may be adapted to run the variety of application programs and controls described above, to access, and to store data, including accessing and storing data in associated databases. Typically, the controller 116 is implemented by one or more programmable data processing devices. The hardware elements, operating systems, and programming languages of such devices are conventional in nature, and it is presumed that those skilled in the art are adequately familiar therewith.

The one or more controllers 116 are embodied in a PC-based implementation of a central control processing system utilizing a central processing unit (CPU or processor), memory and an interconnect bus. The CPU may contain a single microprocessor, or it may contain a plurality of microprocessors for configuring the CPU as a multi-processor system. The memory may include a main memory, such as a dynamic random access memory (DRAM) and cache, as well as a read only memory, such as a PROM, EPROM, FLASH-EPROM, or the like. The system may also include any form of volatile or non-volatile memory. In operation, the memory stores at least portions of instructions for execution by the CPU and data for processing in accord with the executed instructions.

The one or more controllers may also include one or more input/output interfaces for communications with one or more processing systems. One or more such interfaces may enable communications via a network, e.g., to enable sending and receiving instructions electronically. The communication links may be wired or wireless.

The one or more controllers may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller. For example, the one or more controllers may include a graphics subsystem to drive the output mechanism. The links of the peripherals to the system may be wired connections or use wireless communications.

Although summarized above as a PC-type implementation, and shown as such in FIG. 1, those skilled in the art will recognize that the one or more controllers also encompasses systems such as host computers, servers, workstations, network terminals, and the like. Further, one or more controllers may be embodied in a device, such as a mobile electronic device, like a smartphone or tablet computer. In fact, the use of the term controller is intended to represent a broad category of components that are well known in the art.

Aspects of the systems 100 and methods provided herein encompass hardware and software for controlling the relevant features and functions described herein. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical disks, magnetic disks, and solid-state drives, such as any of the storage devices in the user device 102 shown in FIG. 1. Volatile storage media include dynamic memory, such as the memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller can read programming code and/or data. Many of these forms of computer readable media may be involved in carrying one or more sequences of one or more instructions to a processor for execution.

Without further elaboration, it is believed that one skilled in the art can use the preceding description to utilize the claimed inventions to their fullest extent. The examples and embodiments disclosed herein are to be construed as merely illustrative and not a limitation of the scope of the present disclosure in any way. It will be apparent to those having skill in the art that changes may be made to the details of the above-described embodiments without departing from the underlying principles discussed. In other words, various modifications and improvements of the embodiments specifically disclosed in the description above are within the scope of the appended claims. For example, any suitable combination of features of the various embodiments described is contemplated.

We claim:

1. A positioning alert system for determining positioning of an aircraft, the positioning alert system comprising:
a database for storing threshold data;
an inclinometer configured to monitor an angle of the aircraft relative to horizontal;
a global positioning system (GPS) configured to monitor a speed of the aircraft relative to a speed of the water under the aircraft;
a radar, lidar, or ultrasound altimeter configured to monitor altitude data;
a vertical speed indicator configured to monitor a rate of climb or descent of the aircraft;
a controller in communication with the inclinometer, the GPS unit, and the radar altimeter; and
a memory coupled to the controller, wherein the memory is configured to store program instructions executable by the controller, wherein, in response to executing the program instructions, the controller is configured to:
receive data from the inclinometer, the GPS unit, the radar altimeter, and the vertical speed indicator;
identify a threshold angle of incidence of the floatplane stored in the database;
determine an angle of incidence of the floatplane in real-time;
compare the angle of incidence to the threshold angle of incidence; and
provide an alert once the angle of incidence reaches the threshold angle of incidence.

2. The positioning alert system of claim 1, wherein the threshold angle of incidence is a minimum angle of incidence for hydroplaning during takeoff.

3. The positioning alert system of claim 2, the threshold angle of incidence is based on flight history of the floatplane.

4. The positioning alert system of claim 2, the threshold angle of incidence is user selected.

5. The positioning alert system of claim 2, wherein the alert includes instructions to transition a pitch attitude to the step.

6. The positioning alert system of claim 1, wherein the threshold angle of incidence is a maximum angle of incidence during landing.

7. The positioning alert system of claim 6, the threshold angle of incidence is based on flight history of the floatplane.

8. The positioning alert system of claim 6, the threshold angle of incidence is user selected.

9. The positioning alert system of claim 6, wherein the controller is configured to provide instantaneous height above horizontal and a descent rate.

10. The positioning alert system of claim 1, wherein the inclinometer comprises a one to three-axis gyroscope.

11. The positioning alert system of claim 1, the controller is configured to provide continuous pitch data on a display.
